(19) United States
(12) Patent Application Publication
(10) Pub. No.: US 2021/0393482 A1
(43) Pub. Date: Dec. 23, 2021

(54) DEVICE FOR STORING GOODS TO BE STORED IN A TEMPERATURE-CONTROLLED MANNER

(71) Applicant: PRODUCTBLOKS GMBH, Vienna (AT)

(72) Inventors: Dominik Radler, VIENNA (AT); Filip Kitanoski, Vienna (AT)

(21) Appl. No.: 17/293,034

(22) PCT Filed: Nov. 12, 2019
(86) PCT No.: PCT/AT2019/060382

§ 371 Date: May 11, 2021

(30) Foreign Application Priority Data
Nov. 13, 2018 (AT) A 50990/2018

(51) Int. Cl. A61J 1/16; B01L 7/00; B01L 9/06

(52) U.S. Cl. CPC A61J 1/165; B01L 7/00; B01L 2300/123; B01L 2300/1838; B01L 9/06

(57) ABSTRACT

Various embodiments of the present disclosure are directed to temperature-controlled storage. In one example embodiment, a device for temperature-controlled storage is disclosed including a plurality of receiving areas for items to be stored. At least some of the plurality of receiving areas include temperature control medium lines, temperature control medium and at least one elastic element. The temperature control medium flows through the temperature control medium lines and thereby controls the temperature of the items to be stored. The at least one elastic element secures the items to be stored.

The invention relates to a device for the temperature-controlled storage of items to be stored, in particular liquid substances such as blood samples, wherein the device has receiving areas for the items to be stored, and wherein at least some of the receiving areas have temperature control medium lines, through which temperature control medium flows for controlling the temperature of the items to be stored.

Devices of this type are mainly used for storing sensitive products. Products such as living cells in blood or tissue samples, for example, can be stored therein at a defined temperature. The sample can on the one hand be cooled, for example to a few degrees Celsius or to well below the freezing point of water. On the other hand, the product can also be kept at an elevated temperature. The latter is particularly of interest when a biological process is to be carried out or stimulated by the storage, for example an incubation.

The items to be stored are usually arranged in suitable storage vessels such as test tubes or bottles made of glass or plastic. It is preferably provided that the storage vessels are dimensionally stable.

CN 250156491 U1 describes a cooling device for blood samples, wherein storage vessels containing the blood samples can be inserted into receiving areas. The receiving areas are supplied with temperature control medium through cooling lines and thus ensure a rapid and energy-efficient cooling of the sample. What is disadvantageous, however, is that the heat transfer is low due to the air gap between the receiving area and the item to be stored, and the time taken to adjust to the optimal temperature depends on the size of the item to be stored and thus on the thickness of the air gap. This also increases the loss of heat or cold when cooling or heating, and thus increases the energy consumption.

The object of the present invention is therefore to provide a device of the described type that has an improved efficiency.

This object is achieved according to the invention in that at least some of the receiving areas that have temperature control medium lines have at least one elastic element for securing the item to be stored.

By virtue of the elastic element, the air gap between the receiving area and the item to be stored can be reduced. This enables a better thermal connection, which leads to the temperature of the item to be stored adjusting more quickly to the storage temperature specified by the temperature control means. Thermally unstable products in particular can thus quickly be brought to the specified temperature, and any disintegration or deterioration in quality thereof can be prevented. The elastic element should be flexurally rigid enough that it sufficiently secures the item to be stored in the receiving area, but should be elastic enough that it can be removed when necessary. The elastic element preferably does not significantly deform the secured item to be stored.

Here, securing means that the position of the item to be stored is stabilized to such an extent that it does not leave its position without sufficient external influence, such as for example by being pulled out by a user.

A further advantage results in that different-sized items to be stored can thus be arranged in the receiving area. Unnecessary air gaps can thus be prevented, even if the item to be stored is smaller or has a geometry that does not match the receiving area.

A water-glycol mixture is advantageous as the temperature control medium, particularly when cooling the items to be stored, since said mixture can easily be handled and cooled, is inexpensive, and is non-toxic. Such a mixture is particularly advantageous in the case of cooling temperatures of 0-10° C. or when heating to above room temperature. Accordingly, an anhydrous temperature control medium such as oil or mineral oil may be useful in the case of setpoint temperatures of 100° C. or above. Another alternative would be to use directly evaporating substances as the temperature control medium, so as to achieve an even more uniform temperature distribution within the items to be stored.

It may be provided that at least one spring element, as the elastic element, pushes the temperature control medium line in the direction of a receiving opening for receiving the item to be stored in the receiving area. In this case, the spring element may for example be configured directly as a wire spring, which preferably pushes a connection area of the temperature control medium line in a spring-loaded manner into a receiving opening of the receiving area. When an item to be stored is pushed into the receiving opening, the temperature control medium line is thus elastically pushed back by the item to be stored, to such an extent that there is enough space for said item.

The connection area preferably has a good thermal connection to the temperature control medium line, so that heat can also be dissipated via the latter. It may also be provided that the spring element in the receiving opening is arranged opposite the temperature control medium line and protrudes into the receiving opening. The item to be stored is thus pushed onto the temperature control medium line. Alternatively, the spring element may also be arranged between the coolant line and the receiving opening. The spring element should preferably have high thermal conductivity.

A receiving opening is understood here to mean a recess of the receiving area which is suitable for receiving at least part of the item to be stored. It is generally an opening having a hole for inserting the item to be stored, side walls, and preferably also a base.

The spring element may also be configured as an elastic textile such as a sponge.

It is particularly advantageous if at least one temperature control medium line is configured to be at least partially elastic. The temperature control medium line itself can thus act as an elastic element and can thus adapt to the outer contour of the item to be stored. The temperature control medium line is thus the elastic element. This enables a particularly good thermal transfer.

Suitable materials for the temperature control medium line are in particular elastic plastic, rubber, or composite materials formed of textiles and plastics.

It may be advantageous if the temperature control medium line has at least one layer which is configured to be elastic. In particular, if the temperature control medium line is made of composite material at least in the elastic region, this can lead to a flexible, elastic, but nonetheless tear-resistant and robust design variant.

To achieve an improved heat transfer, the temperature control medium line may be configured to bear at least partially against an item to be stored that is arranged in the receiving area, preferably to bear flat against said item.

If the receiving area has a receiving opening for receiving the item to be stored and the temperature control medium line in the receiving opening protrudes into the receiving opening in an unused position with no item to be stored arranged therein, the temperature control medium line can be displaced by the item to be stored when the item to be stored is inserted into the receiving opening and can be pushed outwards out of the receiving opening. The temperature control medium line thus automatically bears against the item to be stored.

For better heat transfer, it may be provided that the temperature control medium line is configured to be flat at least in the region of a receiving opening for receiving the item to be stored in the receiving area. A particularly large surface area pointing towards the item to be stored can thus be provided.

To ensure particularly effective cooling, it may be provided that a main flow of the temperature control medium of the temperature control medium line leads along the flat region. Here, the main flow means the flow that carries the majority of the temperature control medium. This ensures that the heat transfer functions particularly well and fully in the flat region.

It may be provided that the temperature control medium line in the region of the receiving opening extends substantially over the entire height of the receiving opening.

It is also particularly advantageous if the receiving opening is configured to be substantially cylindrical, and at least one temperature control medium line forms at least a first part of the lateral surface. In this case, the temperature control medium line is preferably at least partially elastic. The temperature control medium line can thus form a pocket, into which the item to be stored can be inserted. The temperature control medium line may extend around the receiving opening in the manner of part a ring, so that it preferably assumes a Q shape. Particularly good cooling is thus achieved.

In this regard, it is particularly advantageous if the receiving opening is configured to be substantially cylindrical, and a first temperature control medium line forms at least a first part of the lateral surface and a second temperature control medium line forms a second part of the lateral surface of the receiving opening. The temperature control medium lines may thus together form an elastic pocket, into which the item to be stored can be inserted.

The first temperature control medium line and the second temperature control medium line may be arranged substantially at the same height or may also be arranged offset from one another. Height is understood here to mean the height of the receiving opening, that is to say the height extending from the hole of the receiving opening into the receiving opening.

To achieve a quicker and more homogeneous adjustment of the temperature of the item to be stored to the temperature of the temperature control medium, the temperature control medium may flow through the first temperature control medium line and the second temperature control medium line in opposite directions.

To facilitate easier removal from storage, in particular automatic removal from storage, it may be provided that the elastic element defines a storage position of an item to be stored that is arranged in the receiving area.

Very efficient cooling is achieved if the device has at least one receiving unit with a plurality of receiving areas, and the temperature control medium lines of the receiving areas of the receiving unit are at least partially connected to one another in series. This enables effective cooling with little effort and using a simple structure. Alternatively, the temperature control medium lines may also be supplied in parallel.

In particular, if the time intervals at which the items to be stored are arranged in the receiving unit are relatively large, the temperature control of the items to be stored will not be significantly mutually influenced. Preferably, the flow rate of the temperature control medium will in this case be selected in such a way that the temperature of the temperature control medium does not significantly change when arranging an item to be stored at a very different temperature. For example, when very hot items to be stored are placed into storage, the temperature of the temperature control medium flowing past should nevertheless rise only by a few tenths of a degree if the item to be stored is intended to reach a setpoint temperature of, for example, 6° C. and the temperature control medium accordingly also has this temperature.

It may be provided that a plurality of receiving units are provided, the temperature control medium lines of which are connected to one another in parallel. A plurality of receiving units may thus be arranged one above the other or one next to the other, which saves space.

Here, in series will be understood to mean that the temperature control medium first flows through the temperature control medium line of one receiving area and then flows through the temperature control medium line of a further receiving area or of multiple receiving areas, before being adjusted to a setpoint temperature by a heat sink or heat source. In parallel will be understood to mean that one portion of the temperature control medium flows through one temperature control medium line and a further portion flows through one or more further temperature control medium lines, and then these portions are combined again. In other words, when two temperature control medium lines are connected in series, the outlet of the first temperature control medium lines is connected to the inlet of the second. In the case of a parallel connection, the inlets of the first and second temperature control medium lines and the outlets of the two temperature control medium lines are accordingly connected to each other. The receiving units also permit any combination of receiving areas connected in parallel and in series.

For example, the evaporator of a compression refrigeration system or a thermoelectric system (e.g. Peltier element) may be used as the heat sink, and an electrical heating element or the condenser of a compression refrigeration system may be used as the heat source.

The device may be configured in such a way that the receiving units can also be plugged together or unplugged from one another in a modular manner.

To achieve automatic or semi-automatic storage, the device may have at least one gripper arm for placing the items to be stored into the receiving areas, removing said items therefrom, or repositioning said items. In this case, either the device or each receiving unit or both may have an insulated outer casing, with items to be stored being able to be inserted and removed at a defined insertion and removal point. According to requirements, the gripper arm can arrange pushed-in items to be stored in the receiving areas or can move stored items from the receiving areas to the region of the insertion and removal point so as to be removed.

If at least some of the temperature control medium lines are connected to at least one heat sink or heat source, which preferably comprises at least one compressor, a heat regulation can be achieved in a simple manner.

To ensure sufficient cooling, at least some of the temperature control medium lines may be supplied with temperature control medium from at least one heat sink. In this case, one heat sink may be assigned to each receiving unit.

It is particularly advantageous if one receiving unit is assigned to each heat sink or heat source. The heat sink or heat source can thus act together with the receiving unit as one unit and can be operated independently.

The invention will be explained in greater detail below with reference to the non-limiting embodiment variants shown in the figures, in which:

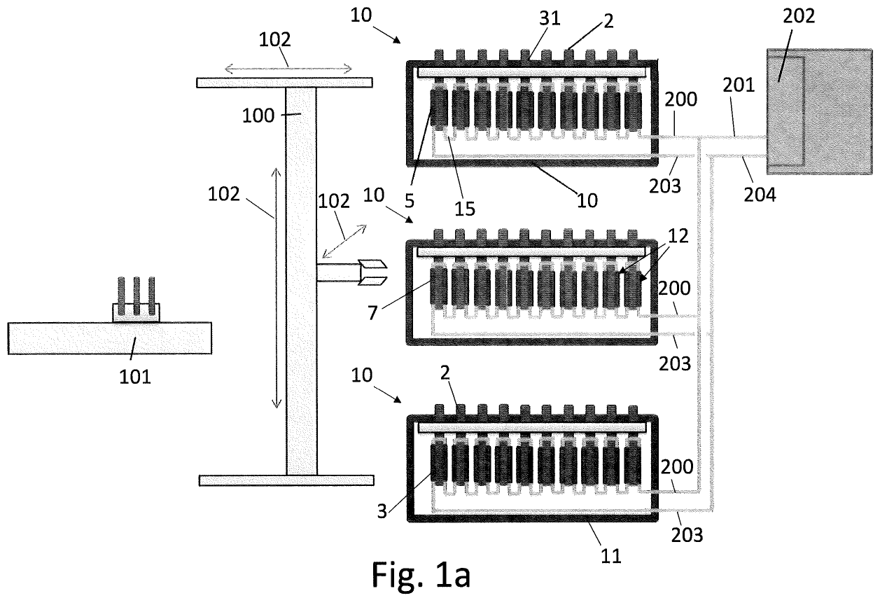

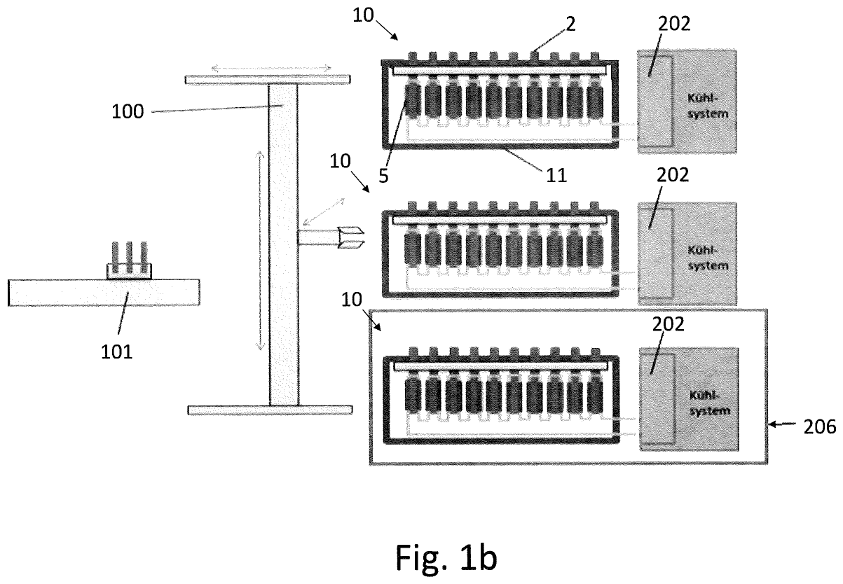

FIG. 1a shows a schematic side view of a first embodiment of a device according to the invention;

FIG. 1b shows a schematic side view of a second embodiment of a device according to the invention;

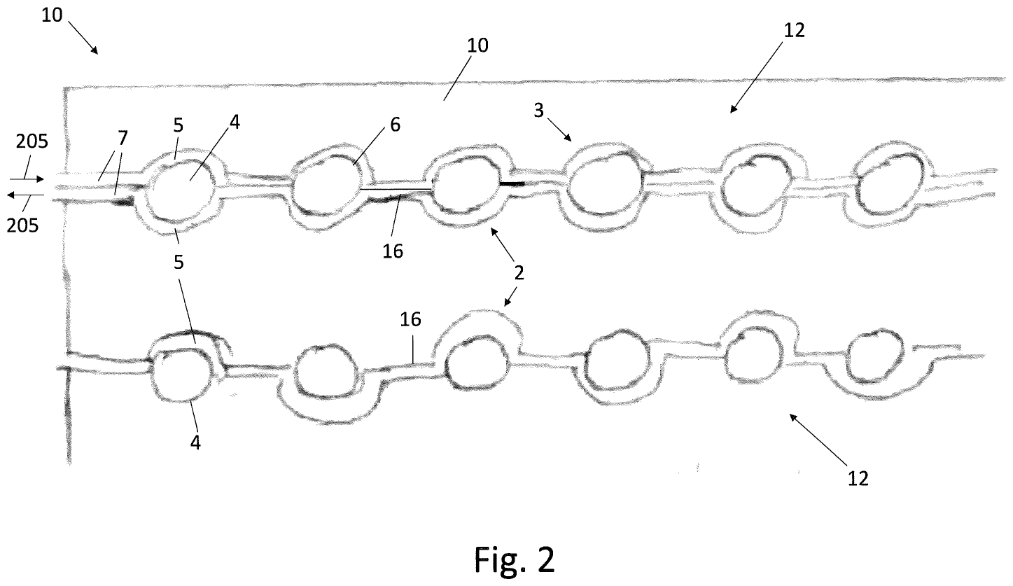

FIG. 2 shows part of a receiving unit with different embodiments of receiving area rows, in a plan view;

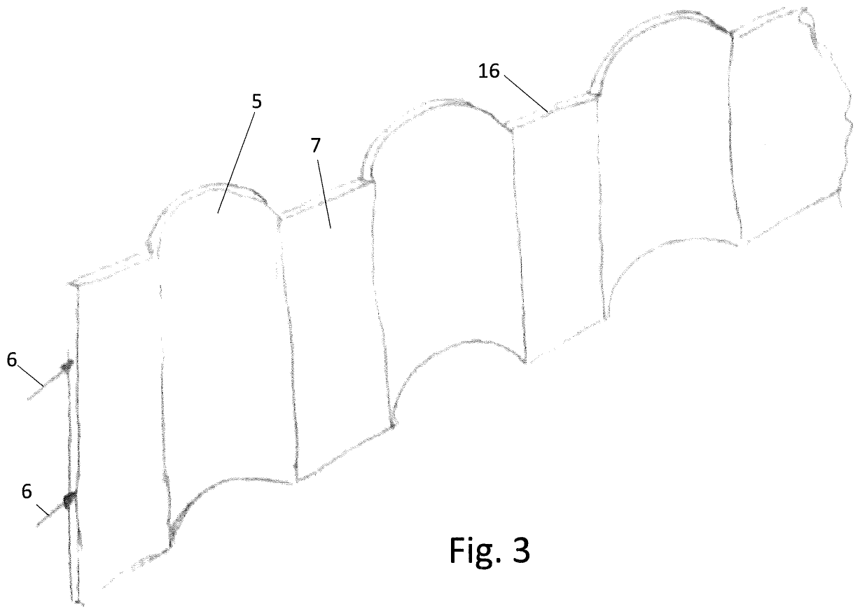

FIG. 3 shows a schematic oblique view of a temperature control medium line;

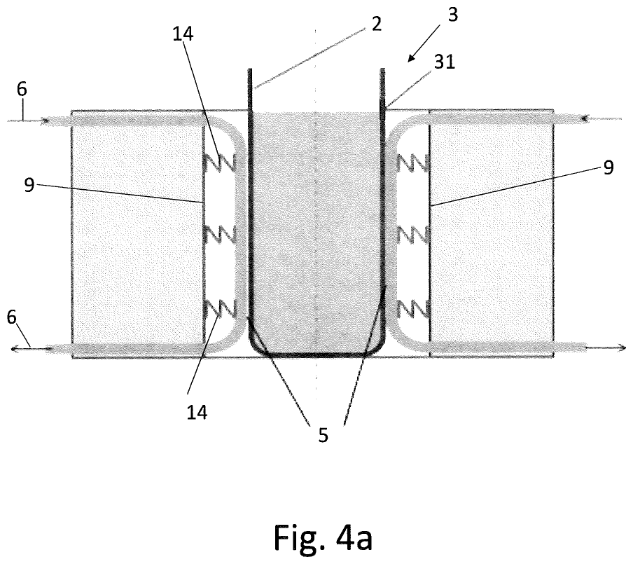

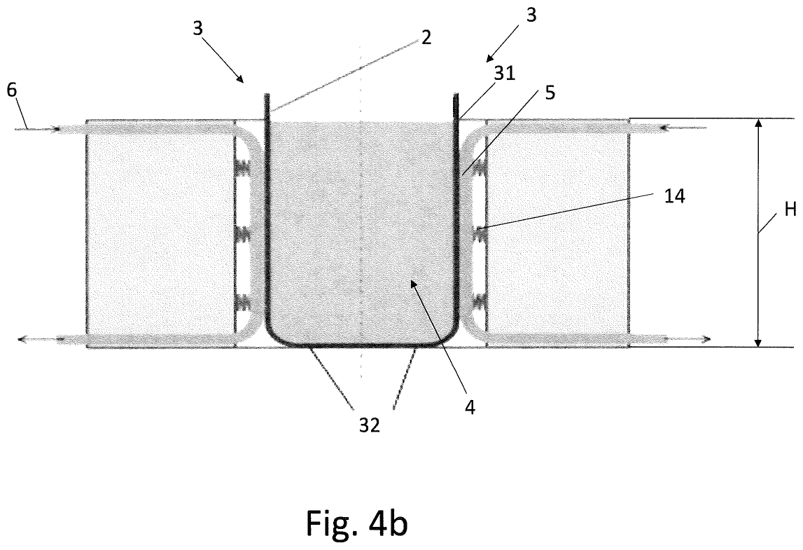

FIGS. 4a and 4b show one embodiment of a receiving area in a sectional view.

FIG. 1a shows a device 1 in a first embodiment, having a gripper arm 100, which is movable in all directions 102, and three receiving units 10. The receiving units 10, connected in parallel, are supplied with temperature control medium from a heat sink 202 comprising a compressor, that is to say a cooling system. To this end, each inlet line 200 of the receiving units 10 is connected to a supply line 201 of the heat sink 202, and each outlet line 203 of the receiving units 10 is connected to the return line 204 of the heat sink 202. Each receiving unit 10 has a total of ten receiving area rows 12, each having a plurality of receiving areas 3, into which items 2 to be stored can be inserted by the gripper arm 100 through a hole 31. The receiving areas 3 of each receiving area row 12 are arranged in a row, the receiving area rows 3 being arranged next to one another. The receiving area rows 3 are supplied in series by the supply line 201 and discharge the used temperature control medium via the outlet line 203.

Each receiving unit 10 additionally has a thermally insulating casing 11. The receiving units 10 are thus substantially independent of one another, and if one receiving unit 10 is unplugged or becomes defective there is no general failure of all the other receiving units 10. Furthermore, the temperature-controlled chamber is thus kept as small as possible; the gripper arm 100 need not be arranged in the interior of the temperature-controlled chamber. The items 2 to be stored may protrude upwards out of the temperature-controlled areas, but this does no harm since this surface area is very small and the product is pulled by gravity into the lower part of the item 2 to be stored, so that the product in the item 2 to be stored can be kept at a constant temperature and the energy losses are low. Alternatively, thermally insulating closure mechanisms such as flaps may be provided, which upwardly close the item 2 to be stored and can be automatically opened by the gripper arm 100.

Here, directional indications such as top or bottom are based on the device 1 being arranged as intended, in which the holes 31 of the receiving areas 3 substantially point away from the Earth's surface. However, it must be noted that embodiments in which the receiving areas 3 have other orientations are also possible.

The gripper arm 100 can move items 2 to be stored between the receiving areas 3 or between the receiving areas 3 and an input/output surface 101. Items 2 to be stored can thus simply be arranged on the input/output surface 101 so that the gripper arm 100 can stow them in the receiving areas 3. When a stored item 2 is required, a command can thus be sent to the gripper arm 100 via an input unit, such as a computer interface, in order to initiate the removal from storage. Means such as barcode readers, RFID systems or the like may be provided, which recognize the items to be stored and automatically arrange them in a storage system.

In an alternative embodiment, each receiving unit 10 may have its own heat sink 202, or optionally a heat source. The receiving units 10 need no longer be connected via a common supply line 201 and/or return line 204.

Within each receiving unit 10, the receiving areas 3 are arranged in receiving area rows 12. Each receiving unit has two line strands 7, which cool the receiving areas 3 and are arranged on each side of the receiving areas 3 of the receiving area rows 12. The line strands 7 are connected to one another in series, the transition lines 15 between the line strands 7 being insulated in order to avoid thermal losses. This results in a single temperature control medium path within the receiving unit 10. Alternatively, the receiving area rows 12 may also be arranged parallel to one another.

FIG. 1b shows an alternative, second embodiment, which is very similar to the first. Only the main differences will be discussed here. One heat sink 202 is assigned to each receiving unit 10. This results in three completely independent, easily transportable functional units 206 which can be operated and moved independently of one another. In the embodiment shown, they are arranged one above the other within the range of motion of the gripper arm 100, so that the gripper arm 100 can populate them. Here, “one above the other” is meant in relation to the ground. Alternatively, each functional unit 206 can also be used without a gripper arm 100, by populating it manually.

FIG. 2 shows part of a receiving unit 10, wherein two receiving area rows 12 with receiving areas 3 arranged in rows therein are shown in part. For a better view, two differently configured receiving area rows 10 are shown. All the receiving areas 3 have a cylindrically shaped receiving opening 4.

Each receiving area 3 of a first receiving area row 12 has two temperature control medium lines 5 which are configured to be elastic, said lines having a circular segment-shaped cross-section in the region of the receiving opening 4. One temperature control medium line 5 forms one half and a first part of the lateral surface of the cylindrically shaped receiving opening 4, and the other forms the other half and thus a second part of the lateral surface. Together they thus form a pocket which, when an item 2 to be stored is inserted into a hole 6 of the receiving opening 4, expands to such an extent that the item 2 to be stored easily fits and at the same time is secured counter to the force of gravity. The temperature control medium lines 5 are connected to the temperature control medium lines 5 of the adjacent receiving areas 3, so that temperature control medium, after flowing through the temperature control medium lines 5 of one receiving area 3, can flow through the temperature control medium lines 5 of the adjacent receiving areas 3. This results in two continuous line strands 7, which connect the receiving areas 3 to one another. The temperature control medium lines 5 are connected to one another at one end and thus the flow therein takes place in different directions, as shown by arrows 205.

The receiving areas 3 of the second receiving area row 12 each have only one temperature control medium line 5, which likewise have a circular segment-shaped cross-section, these covering more than half of the lateral surface. They are also connected to temperature control medium lines 5 of the adjacent receiving areas 3. This results in a Q shape of the temperature control medium lines 5, which form pockets for the items 2 to be stored. The temperature control medium lines 5 of the adjacent receiving areas 3 are arranged on different sides of the lateral surface. This results in an alternating orientation of the pockets along the row of receiving areas 3.

The substantially straight connecting regions 16 of the line strands 7 between the receiving areas 3 are preferably thermally insulated.

At least in the region of the receiving openings 4, the temperature control medium lines 5 are configured to be so elastic that no further spring element is necessary. FIGS. 4a and 4b show an alternative embodiment, in which additional spring elements are provided.

FIG. 3 shows part of a line strand 7 of one receiving area row 12 from FIG. 2. It can be seen here that the line strand 7 is configured as a one-piece flat hose which includes all the temperature control medium lines 5 of this strand. This results in multiple, curved temperature control medium lines 5 which have flat regions that provide a large connection area to the item 2 to be stored. A main flow 6 flows from an inlet 8, along the lateral surfaces of the receiving openings 4, to an outlet.

A flow through the temperature control medium lines 5 thus takes place in such a way as to flow tangentially around the main axis of the items 2 to be stored. This main axis thus extends substantially along the direction of insertion into the receiving area 3. This enables not only a uniform cooling of the item 2 to be stored, but also a simple series cooling arrangement of multiple receiving areas next to one another. Alternatively, the flow through the temperature control medium lines 5 may also take place axially for example.

FIGS. 4a and 4b each show the same receiving area 3 with different items 2 to be stored arranged therein. Between a fastening wall 9 and the two temperature control medium lines 5 arranged at the same height, spring elements 14 are provided at three different heights of the receiving opening 4, said spring elements being configured as steel springs. These push the temperature control medium lines 5 into the receiving opening 4, thereby narrowing the latter. The receiving opening 4 has a height H which is bounded at one side by the hole 31 and at the other side by a boundary wall 32. The temperature control medium lines 5 extend over the entire height H. In an alternative embodiment, the boundary wall 32 may also be arranged at a distance from the temperature control medium lines 5, as a result of which it is possible to store even longer items 2 to be stored. The spring elements 14 should be so flexurally rigid that they even secure items 2 to be stored that do not extend as far as the boundary wall 32.

If, as shown in FIG. 4a, an item 2 to be stored that is of small diameter is inserted, the walls of the item 2 to be stored push the temperature control medium lines 5 outwards. The elastic spring elements 14 yield and enable the insertion, with the temperature control medium lines 5 bearing against the item 2 to be stored and securing it in position to such an extent that it cannot leave this position and fall through without external force being applied.

If, as shown in FIG. 4b, a thicker item 2 to be stored is inserted, the spring elements 14 correspondingly yield elastically to a greater extent, as a result of which also this item can be received and secured.

The spring elements are evenly distributed in the cross-section of the receiving opening 4 and are configured to be equally elastic, so that a stored item 2 to be stored is always centred in the receiving opening 4, regardless of its size. The item 2 to be stored is thus secured in a defined position. This is particularly advantageous when being removed from storage by a gripper arm 100.

1. Device for the temperature-controlled storage of items, the device comprising:
a plurality of receiving areas configured and arranged to receive items to be stored, at least some of the plurality of receiving areas include
temperature control medium lines,
temperature control medium configured and arranged to flow through the temperature control medium lines and thereby control the temperature of the items to be stored, and
at least one elastic element configured and arranged for securing the items.

2. The device of claim 1, wherein the plurality of receiving areas further include a receiving opening configured and arranged to receive the item to be stored;
wherein the at least one elastic element is at least one spring element configured and arranged to push one or more of the temperature control medium lines in the direction of the receiving opening.

3. The device of claim 1, characterized in that at least one of the temperature control medium lines is at least partially elastic.

4. The device of claim 3, characterized in that the temperature control medium line has at least one layer which is elastic.

5. The device of claim 1, characterized in that the temperature control medium lines are configured and arranged to bear at least partially against the item arranged in the receiving area.

6. The device of claim 1, wherein the plurality of receiving areas further include a receiving opening configured and arranged to receive the item to be stored, and
wherein a portion of the temperature control medium line is configured and arranged to protrude into the receiving opening in an unused position without an item to be stored arranged therein.

7. The device of claim 6, wherein the temperature control medium line is further configured and arranged to be flat at least in the region of the receiving opening for receiving the item to be stored.

8. The device of claim 7, characterized in that a main flow of the temperature control medium of the temperature control medium line leads along the flat region.

9. The device of claim 6, wherein the temperature control medium line in the region of the receiving opening0 extends substantially over an entire height of the receiving opening.

10. The device of claim 6, wherein the receiving opening is configured to be substantially cylindrical, and at least a first temperature control medium line forms at least a first part of a lateral surface of the receiving opening.

11. The device of claim 10, wherein a second temperature control medium line forms a second part of the lateral surface of the receiving opening.

12. The device of claim 11, wherein the first temperature control medium line and the second temperature control medium line are arranged substantially at the same height.

13. The device of claim 11, wherein the temperature control medium flows through the first temperature control medium line and the second temperature control medium line in opposite directions.

14. The device of claim 1, wherein the at least one elastic element defines a storage position of the item in the receiving area.

15. The device of claim 1, wherein the device further includes at least one receiving unit with a plurality of receiving areas, and the temperature control medium lines configured and arranged to protrude into each of the plurality of receiving areas are at least partially connected to one another in series.

16. The device of claim 15, further including a plurality of receiving units, the temperature control medium lines associated with each of the plurality of receiving units are connected to one another in parallel.

17. The device of claim 1, further including at least one gripper arm configured and arranged for placing the items into the receiving areas, removing said items therefrom, or repositioning said items.

18. The device of claim 1 to 15, further including at least one heat sink or heat source, and wherein at least some of the temperature control medium lines are connected to the at least one heat sink or heat source.

19. The device of claim 18, characterized in that the at least one receiving unit is assigned to each heat sink or heat source.

20. The device of claim 1, wherein the items to be stored are blood samples.
